(19) United States
(12) Patent Application Publication
(10) Pub. No.: US 2005/0030758 A1
(43) Pub. Date: Feb. 10, 2005

(54) Complex reflector formed by sectors with rotational symmetry for a vehicle headlamp, and process of manufacture

(75) Inventors: Davide Capello, Orbassano (Torino) (IT); Piermario Repetto, Orbassano (Torino) (IT); Pietro Perlo, Orbassano (Torino) (IT)

Correspondence Address: SUGHRUE MION, PLLC, 2100 PENNSYLVANIA AVENUE, N.W., SUITE 800, WASHINGTON, DC, 20037, US

(73) Assignee: C.R.F. SOCIETA CONSORTILE PER AZIONI

(21) Appl. No.: 10/910,348

(22) Filed: Aug. 4, 2004

(30) Foreign Application Priority Data
Aug. 5, 2003 (IT) TO2003A000611

(51) Int. Cl. F21W 11/10

(52) U.S. Cl. 362/516

(57) ABSTRACT

A reflector for a vehicle headlamp capable of generating a light beam and directing it with respect to an optical axis in order to illuminate the surrounding space according to a predetermined luminosity distribution is described. The reflector is subdivided into a plurality of reflecting sectors capable of reflecting the light emitted from a light source located along an optical axis of the headlamp in order to obtain the said luminosity distribution. Each segment of the reflector is formed by a portion of a surface having rotational symmetry about a corresponding axis. This axis is orientated with respect to the optical axis of the headlamp in such a way that the corresponding sector is capable of directing the light from the light source into a predetermined spatial region of the luminosity distribution.

This invention relates in general to vehicle headlamps capable of generating a light beam and directing it with respect to an optical axis so as to illuminate the surrounding space according to a predetermined luminosity distribution and in particular a reflector for a vehicle headlamp of the type defined in the preamble of claim 1.

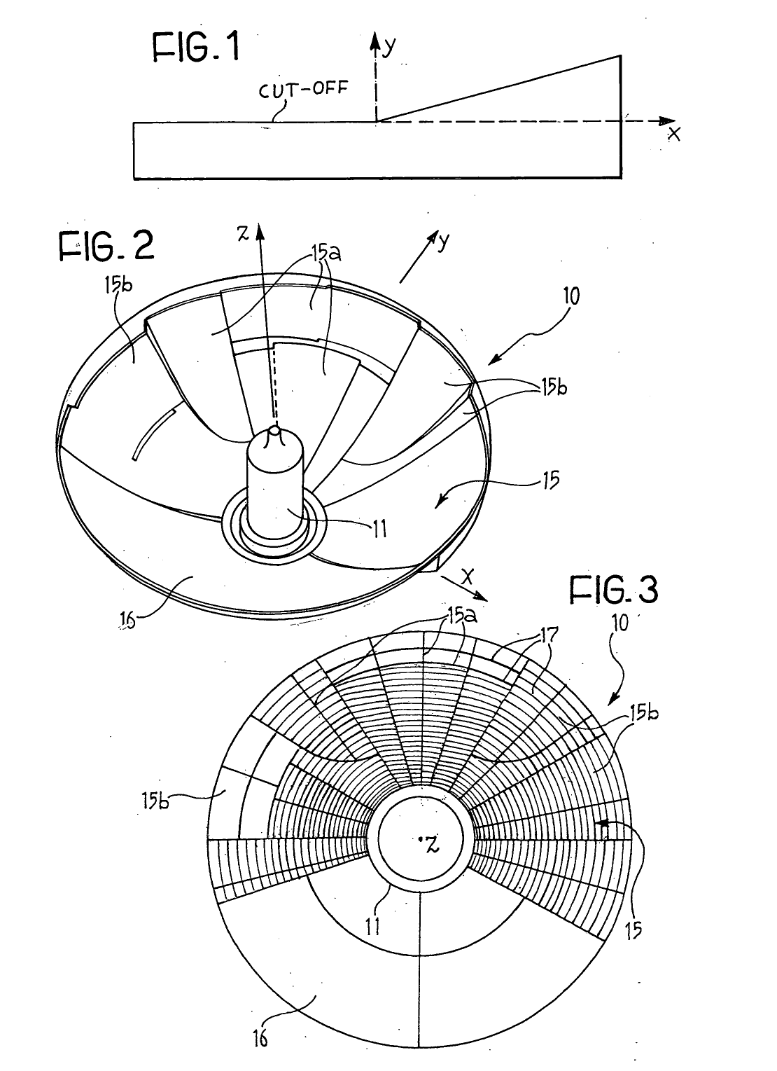

Stylistic and performance requirements have always pushed the motor vehicle industry towards the use of smaller sized headlamps with a smooth glass and complex reflecting surfaces. The main problems in the design of a reflector of this type are associated with limiting glare in the dipped beam and control of the light beam to form an illumination distribution which complies with the regulations. According to applicable European regulations (see FIG. 1) the shape of the dipped beam generated by a vehicle headlamp must be such as to create, on a plane located at a particular distance from the headlamp, a luminosity distribution which shows a sudden change in illumination in the vertical direction corresponding to the horizontal axis, or X axis, located at the level of the optical axis of the headlamp. This discontinuity, known as the “cut-off”, is necessary in order to ensure maximum illumination immediately beneath the horizontal line and virtually zero illumination immediately above the said line.

These problems become even more significant for reflectors using a two-filament lamp source, of the type classified as H4. This source is provided with two filaments, one for the high beam function and one for the dipped function; part of the dipped filament is masked by a screen which generates a shadow on half the reflector. This half of the reflector shadow is typically used for the high beam function, while the complementary half, optimized for the dipped function, is also utilized for the high beam function.

From the point of view of the reflector's optical designing the screen makes the filament for the dipped function a virtual source which is equivalent to having an effective source of a size greater than the filament itself, or an angular widening of the light beam from each point on the surface of the reflector. The angular widening of the light beam, that is the angular image of the source, from each point on the surface of the reflector depends on the size of the source seen from the reflector at the point in question and the distance between the source and the point on the reflector. The greater the distance, the less will be the angular dimension of the beam.

Different parts of the reflector therefore produce different images of the source with different intensities and dimensions. Generally the points on the reflector which are most distant from the light source produce smaller images of less intensity because they receive a lesser flux. Vice versa the points closest to the light source produce larger images of greater intensity.

This makes it necessary to subdivide the reflector into several sectors, using the sectors in which the angle subtended by the source is smaller in order to form zones of luminosity distribution having a greater spatial illumination gradient (i.e. those closest to the cut-off line); the beam widening angle may be altered by constructing a glass with prismatic portions, but the general trend in style is to manufacture headlamps with a smooth glass in which the optical function is completely achieved through the reflector.

In general the sectors forming the headlamp have a complex surface which makes it possible to direct the light originating from the light source into a predetermined part of the luminosity distribution. By complex surface is meant a surface without rotational or cylindrical symmetry, or which cannot be obtained by the rotation or translation of a curve with respect to an axis, but through the mixing or “blending” of several curves, or through the displacement or “sweep” of a curve along a generic curve.

This type of surface is obtained by mechanical milling. Milling does not guarantee a sufficiently good surface optical quality for it to be possible to do away with further polishing operations. Also, if the reflector is machined as a single segmented unit, further rounding has to be introduced at the points of discontinuity between the segments because of the radius of curvature of the tool.

Both these factors contribute to introducing deviations between the calculated surfaces and those actually obtained through machining; in addition to this the moulded part will have further rounding due to non-perfect filling of the mould at the corners, and this is particularly significant if thermoplastic materials are used. The subsequent operations of overall painting and deposition of the reflecting surface add further error factors.

All these factors taken together have the result that the performance of the reflector is decidedly worse than that envisaged in simulation; in compact reflectors, which are particularly critical from the performance point of view, the deterioration may make it impossible to gain approval for the headlamp.

The purpose of this invention is to provide a reflector for a vehicle headlamp whose manufacture is less subject to the abovementioned error factors and whose final properties are therefore closer to those envisaged at the design stage.

This object is achieved through a reflector for a vehicle headlamp having the characteristics defined in the claims.

A further object of the invention is a process for the manufacture of a reflector according to the invention having the characteristics defined in the claims.

Preferred but not restrictive embodiments of the invention will now be described with reference to the appended drawings, in which:

FIG. 1 is a schematic diagram illustrating the luminosity distribution generated by a motor vehicle headlamp according to European regulations,

FIG. 2 is a perspective view of a vehicle headlamp comprising a reflector according to the invention,

FIG. 3 is a diagrammatical view in plan of the headlamp in FIG. 2,

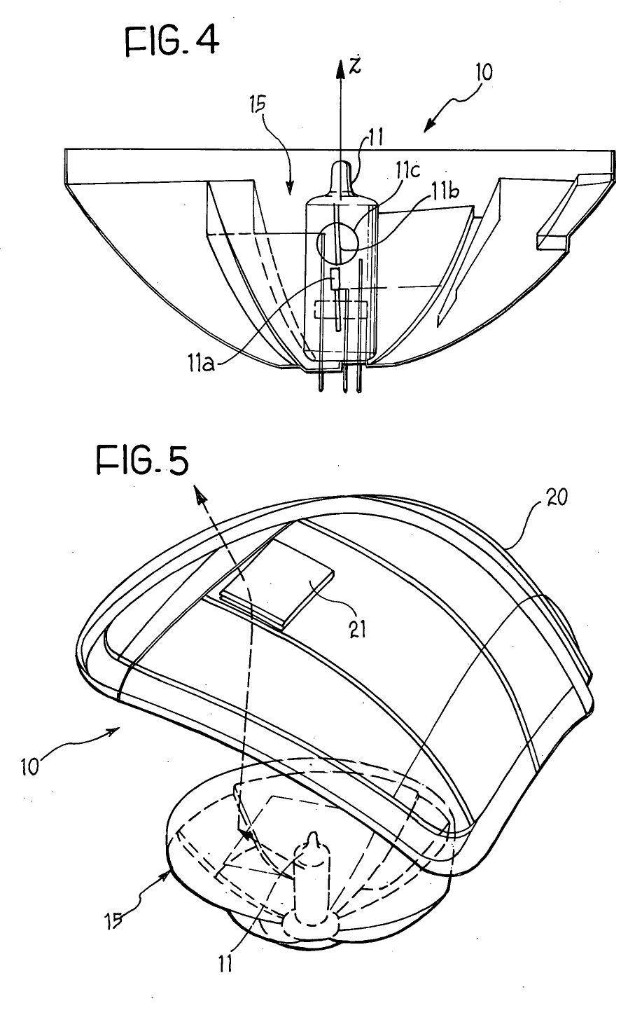

FIG. 4 is a view of the headlamp in FIG. 2 in longitudinal cross-section,

FIG. 5 is a diagrammatical perspective view of a variant of the headlamp in FIG. 2.

With reference to FIGS. 2 to 4, a headlamp 10 according to the invention capable of generating a light beam and directing it with respect to an optical axis so as to illuminate the surrounding space according to the luminosity distribution in FIG. 1 is illustrated. For simplicity, this headlamp is illustrated without a glass, and its shape and structure may be widely varied without going beyond the scope of the invention.

This headlamp 10 comprises a light source 11, in the present example illustrated as an incandescent lamp with two filaments of the type classified as H4. This lamp 11 of a conventional type has a filament 11a capable of generating a light beam of high beam depth and a filament 11b capable of providing a dipped light beam located in front of filament 11a. Of course the lamp may be of another known type, for example of the discharge type.

A reflector 15, having a shape which for example has circular symmetry, in particular a paraboloid shape, or any shape known in the art, and subdivided into a plurality of reflecting sectors 15a, 15b is arranged around lamp 11. For simplicity reference will always be made to a paraboloid shape in what follows.

In order to generate the high light beam the filament 11a of lamp 11 is located at the focus of reflector 15 in a known way.

In order to generate the dipped light beam filament 11b of lamp 11 is orientated in such a way that its axis is parallel to an optical axis Z of headlamp 10 and the bottom part is screened by screening member 11c; in this way the luminosity beam only exits from the upper part of reflector 15 pointing downwards in the condition in which the headlamp is fitted on the vehicle. In order to obtain the luminosity distribution in FIG. 1, which has a clear demarcation line upwards, sectors 15a, 15b have reflecting surfaces orientated in a different way to the surface of the enveloping paraboloid defining reflector 15 on which those sectors are located. For example, sectors 15b, in which the angle subtended by source 11 is smaller are used to form zones of the luminosity distribution having a greater spatial illumination gradient (that is the zones closest to the cut-off line) so that the surfaces of sectors 15b are orientated to reflect the light beam immediately beneath the demarcation or cut-off line. The concept of orientating portions of the surface of the reflector in such a way as to obtain a specific luminosity distribution is already known in the art, and therefore it will not be discussed further in this description.

Sectors 15a and 15b of reflector 15 are designed to form the dipped light beam. A lower portion 16 of reflector 15 is instead designed to generate the high light beam.

According to the invention each sector 15a, 15b of reflector 15 is obtained as a portion of a surface having rotational symmetry about a predetermined axis. This axis is orientated with respect to the optical axis Z of headlamp 10 in such a way that sector 15a, 15b associated with it is orientated so as to direct the light beam from source 11 into a predetermined spatial region of the luminosity distribution.

In FIG. 2 the fact that segments 15a and 15b of the reflector have rotational symmetry is illustrated more clearly. In fact the corresponding contours 17 for each sector 15a, 15b are shown. Segments 15a, 15b of reflector 15 having a greater curvature have closer contours 17, while sectors 15a, 15b having a lesser curvature have contours 17 which are more spaced apart. It will also be seen that only some of sectors 15a, 15b have contours 17 which are concentric with the axis of reflector 15.

The fact of having all sectors 15a, 15b in reflector 15 formed by portions of surfaces with rotational symmetry makes it possible to construct the individual sectors of reflector 15 with a more accurate technique than milling, for example, numerically controlled turning. If, as is preferable, the tool is of high quality, for example of diamond, and the machining pass is carefully selected, machining of the individual sectors 15a, 15b by turning ensures that a high optical quality is achieved on first machining.

After turning, the individual segments 15a, 15b are inclined by the angle at which they are intended to be located in reflector 15, and cut according to a predetermined closed profile, obtaining corresponding wedges. The individual wedges are finally assembled to form the final block for reflector 15.

The block for reflector 15 may be used as a die for moulding the final reflector or, as an alternative, may be used directly for the photometric approval tests. In the latter case a reflecting coating is deposited on the block to increase the value of the reflectance. The good optical quality of the first machining has the result that it is not necessary to use a coating paint between the block and the reflecting coating, thus ensuring almost perfect fidelity between the final surface and the design surface.

The profile of each sector 15a, 15b of reflector 15 is calculated by means of software codes capable of controlling the exit angles of rays reflected at the edge of the sector and the distribution of light flux within it.

The profile of sector 15a, 15b calculated in this way is imported into CAD software in which the rotation surface of the overall reflector 15 is calculated and the rotations of sectors 15a, 15b necessary to orientate the light beam in order to obtain the illumination distribution in FIG. 1 are made. The rotations are made with respect to the optical axis Z of headlamp 10 and source 11.

FIG. 5 illustrates a variant of the headlamp in FIG. 2. In this variant there is a reflector 15 shaped in a way similar to that of the embodiment previously described, which will not therefore be further discussed. In that variant the headlamp has a glass 20 provided with prismatic portions 21 which act together with sectors 15a, 15b of reflector 15 in such a way as to make it possible to obtain a luminosity distribution which is as close as possible to that illustrated in FIG. 1.

By “glass” is meant the external part of headlamp 10 which transmits the light to the illuminating surface of headlamp 10.

Of course, without affecting the principle of the invention construction details and embodiments may be widely varied in comparison with what has been described and illustrated without thereby going beyond the scope of the invention.

1. A reflector for a vehicle headlamp capable of generating a light beam and directing it with respect to an optical axis in such a way as to illuminate the surrounding space according to a predetermined luminosity distribution, the said reflector being subdivided into a plurality of reflecting sectors capable of reflecting the light emitted from a light source located on an optical axis of the headlamp in order to obtain the said luminosity distribution,
wherein each segment of the reflector is formed by a portion of a surface having rotational symmetry about a corresponding axis, the said axis being orientated with respect to the optical axis of the headlamp in such a way that the corresponding sector is capable of directing the light from the light source into a predetermined spatial region of the luminosity distribution.

2. A reflector according to claim 1, in which the said light source is a two-filament lamp capable of selectively generating a high light beam and a dipped light beam, the said reflecting sectors being located in a region of the reflector intended to reflect the dipped light beam.

3. A vehicle headlamp, comprising a reflector according to claim 1.

4. A headlamp according to claim 3, also comprising a glass provided with prismatic portions capable of acting together with the said sectors to generate the said predetermined luminosity distribution.

5. A process for manufacturing a reflector for a vehicle headlamp according to claim 1, comprising the stages of:
machining the individual sectors of the reflector in such a way as to obtain portions of a surface having rotational symmetry,
inclining each sector to a predetermined angle,
cutting each sector to a predetermined closed profile in such a way as to form a wedge, and
assembling the individual wedges in such a way as to form a reflector block.

6. A process according to claim 5, in which the said machining of the sectors is performed by diamond turning.

7. A process according to claim 6, in which the said block is used as a sample for photometric approval of the headlamp.

8. A process according to claim 5, in which the said block is used as a die for moulding a reflector.
